(19) United States
(12) Patent Application Publication
(10) Pub. No.: US 2005/0273653 A1
(43) Pub. Date: Dec. 8, 2005

(54) Single fault tolerance in an architecture with redundant systems

(75) Inventor: Zygmunt Zubkow, Palm Harbor, FL (US)

Correspondence Address: Honeywell International Inc., 101 Columbia Road, Law Dept. AB2, Morristown, NJ, 07962, US

(73) Assignee: Honeywell International Inc.

(21) Appl. No.: 10/848,674

(22) Filed: May 19, 2004

(51) Int. Cl. G06F 11/00

(52) U.S. Cl. 714/11

(57) ABSTRACT

An electronic module is provided. The electronic module includes a first system and a second, redundant system. The first and second redundant systems include at least three processors having health management tasks that operate independently to perform a voting function to identify faults within the electronic module.

### TECHNICAL FIELD

The present invention relates generally to the field of redundant systems and, in particular, to single fault tolerance in an architecture with redundant systems.

### BACKGROUND INFORMATION

At times, electronic systems can operate outside normal parameters thereby producing faulty data. In some circumstances, the failure of these systems can be catastrophic. For example, failure of an electronic control system in a jet engine or other aerospace vehicle can cause the vehicle to depart from a desired trajectory thereby endangering lives of passengers, passengers of other vehicles or bystanders on the ground. As a consequence, many systems include redundant components so that when one system fails, a back-up system is brought on line to function in place of the primary unit.

To further complicate matters, it is not always directly apparent when an electronic system is not functioning properly. For example, the system may still produce data, although the data may be incorrect. This is commonly referred to as the “Byzantine Generals problem” since, in combat, Generals may not always get accurate data from observers during a battle. To combat this problem, data from multiple sources is commonly consulted so that faulty data can be isolated. Similarly in electronic systems, voting mechanisms are used to identify good data from faulty data. The voting mechanisms look at the simultaneous output of redundant systems to determine the correct data.

One assumption with voting mechanisms is that only one fault occurs at a time. This single fault assumption allows identification of the faulty output. Typically, three systems operate simultaneously so that if one system fails, it can be identified by the other two. Essentially, the third system casts the tie-breaking vote. If only two systems are used, it is possible to identify an error, but, not which output is correct.

Navigation systems in aerospace vehicles, e.g., missiles, are subject to potential faults that could cause the vehicle to depart from a programmed trajectory. One type of navigation system is referred to as a Space based Integrated Global positioning/Inertial navigation system (SIGI). To overcome the Byzantine problem, it is possible to use three redundant SIGI systems. This however, is a very expensive proposition due to the expense of each SIGI system.

Therefore, there is a need in the art for an improved architecture that provides a lower cost solution to overcome the Byzantine problem in an architecture having redundant systems.

### SUMMARY

Embodiments of the present invention address the Byzantine problem by using dual processors in redundant systems to thereby reduce the need for a third system. In one embodiment, an electronic module is provided. The electronic module includes a first system and a second, redundant system. The first and second redundant systems include at least three processors having health management tasks that operate independently to perform a voting function to identify faults within the electronic module.

### BRIEF DESCRIPTION OF DRAWINGS

FIG. 1 is an illustration of one embodiment of a single fault tolerant architecture having redundant systems with dual processors.

FIG. 2 is a flowchart of one embodiment of a method of operation of a single fault tolerant architecture having redundant systems with dual processors.

### DETAILED DESCRIPTION

In the following detailed description of the preferred embodiments, reference is made to the accompanying drawings that from a part hereof, and in which is shown by way of illustration specific embodiments in which the invention may be practiced. It is to be understood that other embodiments may be utilized and structural changes may be made without departing from the scope of the present invention.

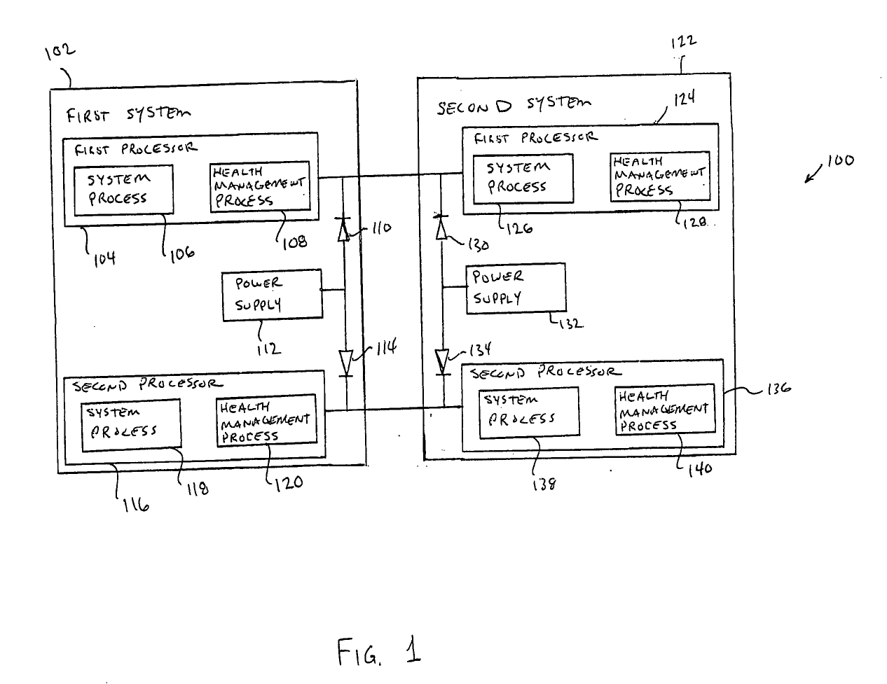

FIG. 1 is an illustration of one embodiment of a system, indicated generally at 100, with a single fault tolerant architecture having first and second, redundant systems 102 and 122. System 100 advantageously achieves single fault tolerance with only two redundant systems by leveraging the processing power of dual processors in each of systems 102 and 122. In one embodiment, the system 100 comprises a dual Space Integrated GPS/INS (SIGI) system with two SIGI systems provided for redundancy. In one embodiment, systems 102 and 122 comprise Enhanced SIGI (E-SIGI) systems. The enhanced SIGI system is an improvement over a general SIGI system in that it has dual processors. First system 102 has a first processor 104 and a second processor 116. Similarly, second system 122 has a first processor 124 and a second processor 136.

In first and second systems 102 and 122, each of the processors 104, 116, 124 and 136 are programmed to perform specified functions for the normal operation of the system 100. For example, the processors in an E-SIGI system provide flight control and navigation functions for the associated aerospace vehicle. In one embodiment, processors 104 and 124 perform the navigation functions for the aerospace vehicle. In one embodiment, the other processors 116 and 136 performs flight control and mission processes.

In addition to the normal system functions performed by each processor, embodiments of the present invention leverage the existence of the four processors to overcome the Byzantine Generals problem by independently running a health management application on each of the processors. This provides four votes to identify system components that are not operating within normal parameters. Thus, each processor 104, 116, 124 and 136 performs two distinct functions. One of these functions includes normal system function represented by system processes 106, 118, 126 and 138. Each processor also performs a health management function represented by health management processes 108, 120, 128 and 140. In terms of the health management process, each of the processors 104, 116, 124, and 136 operates independently of the other processors in system 100.

Processors 104, 116, 124 and 136 are inter-connected with a health management bus 142. The health management bus provides the health information as determined by each processor to the health management process running on each of the other processors. The health status of each voter (processor) is shared by each of the other voters and enables to determine how the first and second systems 102 and 122 are performing. When one of the processors provides different information that the other processors, a fault has been isolated.

The health management bus 142 provides data on a number of parameters between the various processors, e.g., monitored voltages, check sums, status of sub-modules (whether GPS receiver in init mode or operating mode), etc. The status of each submodule provides extended detail of possible faults such as invalid word counts, invalid message number, hardware configuration mismatch, oscillator monitor failure, D/A comparison, temperature sensor failure, digitizer saturation failure, etc.

The function of the health management bus is to communicate the health status of the systems between the processors. In one embodiment, the health management system is performed over either a fault tolerant 1553 bus or an opto-coupled bus. In one embodiment, the health management bus is a transformer coupled bus.

A voting process is performed using all the processors to determine the status of various parameters and consequently faults within the system 100. Each processor receives the same information and performs the same functions during a voting process. Typically, one of processors functions as the coordinator of the voting process.

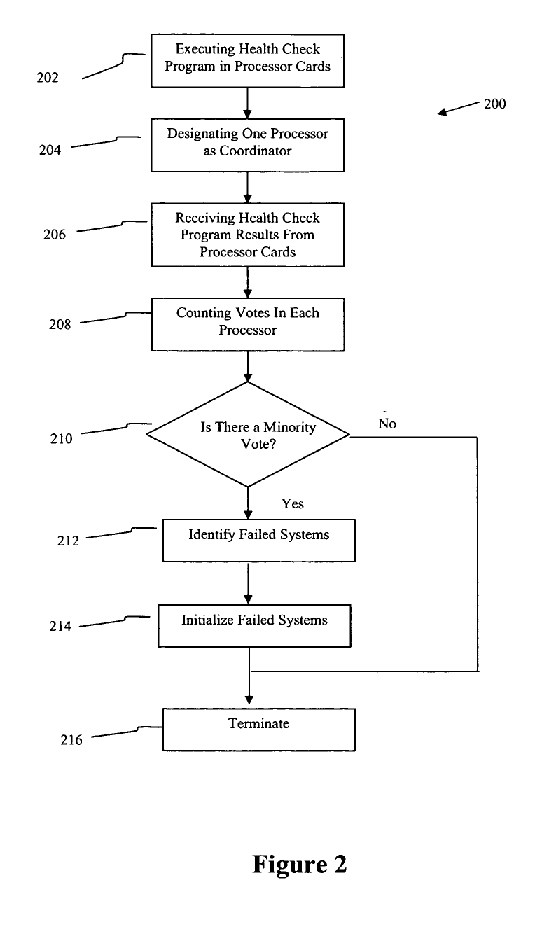

One embodiment of a voting process for identifying faults is described below in conjunction with FIG. 2.

In FIG. 1, the first system 102 and the second system 122 have power supplies 112 and 132 respectively that are cross-strapped for redundancy. Cross-strapping of the power supplies is used to make sure that all processors are still powered if one power supply, or processor circuit card malfunctions. If one power supply fails, the associated processors can still work (even though other aspects, e.g., the GPS receiver, may not be powered). Power supplies 112 and 132 are coupled together and provide power for the four processors 104, 116, 124 and 136. Power supplies 112 and 132 are cross-strapped using a diode-OR architecture using diodes 110, 114, 130 and 134. This ensures redundancy in the event of a power supply failure. In one embodiment, the redundancy of the power supplies is available only to the processors.

The embodiment of FIG. 1 has been described in terms of a system having four processors with health management tasks running on each processor. It is understood, however, that this application does not require that the health management task run on all four processors at the same time. In one embodiment, the health management tasks run on only three of the four processors. This still provides the necessary tie breaking vote in the event of a single fault.

FIG. 2 is a flowchart of one embodiment of a method of operation of a redundant architecture in a system having redundant systems with dual processors according to the teachings of the present invention. The method of FIG. 2 begins at block 202 and executes a health check program in each of the processors. In block 204, one of the processors is designated as the coordinator. The method then proceeds to block 206 where the health check program results are received from the processors. The votes from each of the processors are counted in block 208. At block 210, the presence of a minority vote is checked. When there is no minority vote there is no failure in the system and the method terminates at block 216. Alternatively, when there is a minority vote the method proceeds to block 212. At block 212, the failed system is identified. A single fault in either of the redundant systems can be detected. The method then proceeds to block 214 where the system in failure is identified and appropriate corrective action is taken. For example, if the vote detects a problem with a power supply, the entire system may be taken down and restarted. If, on the other hand, a problem is identified with a particular card in one of the redundant systems, then the particular card may be reset using an appropriate command. Other appropriate steps are taken given the nature of the problem identified through the voting process. Following block 214, the method terminates at block 216.

### CONCLUSION

Embodiments of the present invention have been described. The embodiments provide a redundant architecture that can overcome the Byzantine problem. Ordinarily, three systems are required to establish a proper vote and thereby increasing the overall cost of the architecture. This invention defeats this problem and reduces the cost of the architecture allowing only two systems to determine which system has the problem.

Although specific embodiments have been illustrated and described in this specification, it will be appreciated by those of ordinary skill in the art that any arrangement that is calculated to achieve the same purpose may be substituted for the specific embodiment shown. This application is intended to cover any adaptations or variations of the present invention.

1. A system comprising:
a first system having first and second processors and a first power supply;
a second, redundant system including third and fourth processors and a second power supply;
a health management bus coupled to the first, second, third and fourth processors; and
wherein the first, second, third and fourth processors each run a health management function that identifies faults in the first and second systems.

2. An electronic module, comprising:
a first system;
a second, redundant system; and
wherein the first and second redundant systems include at least three processors having health management tasks that operate independently to perform a voting function to identify faults within the electronic module.

3. The electronic module of claim 2, wherein the first and second systems each comprise an enhanced SIGI system.

4. The electronic module of claim 2, wherein the at least three processors each execute one of navigation functions and flight management functions.

5. The electronic module of claim 2, wherein the health management tasks on the at least three processors communicate over a health management bus.

6. The electronic module of claim 5, wherein the health management bus is opto-isolated.

7. The electronic module of claim 5, wherein the health management bus is transformer coupled.

8. The electronic module of claim 2, wherein
each system includes a power supply; and
each power supply is coupled to all the processors using a diode-OR architecture.

9. An electronic module, comprising:
a first system having a first power supply;
a second, redundant system having a second power supply;
wherein the first and second redundant systems include at least three processors having health management tasks that operate independently to perform a voting function to identify faults within the electronic module;
a health management bus, coupled to the first and second systems, to provide communication between the at least three processors; and
wherein the first power supply and the second power supply are coupled to each of the processors to provide redundant power to each processor.

10. The electronic module of claim 9, wherein the first and second systems each comprise an enhanced SIGI system.

11. The electronic module of claim 9, wherein the at least three processors each execute one of navigation functions and flight management functions.

12. The electronic module of claim 9, wherein the health management bus is opto-isolated.

13. The electronic module of claim 9, wherein the health management bus is transformer coupled.

14. A method for identifying a fault in an electronic module having two redundant systems each including two processors, the method comprising:
executing a health check program on each of the processors of the redundant systems;
designating one of the processors as a coordinator;
receiving the health check program results from each of the processors;
counting votes of the health check program results; and
determining whether there is a fault in the electronic module.

15. The method of claim 14, wherein, when a fault is identified, taking corrective action.

16. A method for identifying a fault in an electronic module having two redundant systems and at least three processors, the method comprising:
executing a health check program on each of the at least three processors of the redundant systems;
designating one of the processors as a coordinator;
receiving the health check program results from each of the processors;
counting votes of the health check program results; and
determining whether there is a fault in the electronic module.

17. The method of claim 16, wherein receiving the health check program results comprises receiving the health check program results over a health bus.

18. The method of claim 16, wherein determining whether there is a fault comprises determining whether there is a minority vote.

19. The method of claim 16, wherein counting the votes comprises counting the votes in the coordinator.

20. The method of claim 16, and further comprising taking corrective action when a fault is detected.

21. The method of claim 20, wherein taking corrective action comprises one of shutting down a system, restarting the system, and resetting a card.

22. A machine readable medium having instructions for a processor to perform a method for identifying a fault in an electronic module having first and second redundant systems with at least three processors, the method comprising:
monitoring health conditions of the electronic module;
receiving signals from the others of the at least three processors regarding health conditions of the electronic module;
correlating the signals from the other processors with the monitored health conditions; and
determining whether there is a fault in the electronic module based on the correlation of the signals with the monitored health conditions.

23. The machine readable medium of claim 22, wherein receiving signals comprises receiving signals over a health bus.

24. The machine readable medium of claim 22, wherein determining whether there is a fault comprises determining whether one of the monitored health signals and the received signals do not agree with the others.

25. The machine readable medium of claim 22, and further comprising taking corrective action when a fault is detected.

26. The machine readable medium of claim 25, wherein taking corrective action comprises one of shutting down a system, restarting the system, and resetting a card.

27. A method for identifying a fault in an electronic module, the method comprising:
monitoring health conditions of the electronic module with at least three processors in first and second redundant systems;
passing signals from each of the at least three processors to the others of the at least three processors regarding health conditions of the electronic module; and
in at least one of the at least three processors,
correlating the signals from the at least two other processors with the monitored health conditions; and
determining whether there is a fault in the electronic module based on the correlation of the signals with the monitored health conditions.
